(19) United States
(12) Patent Application Publication
(10) Pub. No.: US 2023/0149249 A1
(43) Pub. Date: May 18, 2023

(54) METHOD OF IMPROVING STEREOACUITY USING AN INTERVAL-BASED PROTOCOL

(71) Applicant: Amblyotech Inc., East Hanover, NJ (US)

(72) Inventor: Joseph KOZIAK, Phoenix, AZ (US)

(21) Appl. No.: 17/798,020

(22) PCT Filed: Feb. 5, 2021
(86) PCT No.: PCT/US2021/016785

§ 371 Date: Aug. 5, 2022

Related U.S. Application Data
(60) Provisional application No. 62/971,361, filed on Feb. 7, 2020.

(51) Int. Cl. A61H 5/00

(52) U.S. Cl. CPC A61H 5/005; A61H 2201/5043; A61H 2201/1604; A61H 2201/5007; A61H 2201/165

(57) ABSTRACT

A method for improving stereoacuity; it includes presenting weak eye visual information to a weak eye of the patient and dominant eye visual information to a dominant eye of the patient, where a level of the weak eye visual information and a level of the dominant eye visual information are set to an initial ratio; gradually adjusting the initial ratio such that the level of the dominant eye visual information gradually approaches the level of the weak eye visual information; continuous after the previous period of time, setting the level of the weak eye visual information and the level of the dominant eye visual information to a second ratio and gradually adjusting the second ratio such that the level of the dominant eye visual information gradually approaches the level of the weak eye visual information.

### TECHNICAL FIELD

The present disclosure relates to the treatment of visual disorders, diseases and/or conditions, and more particularly to the improvement of stereoacuity.

### BACKGROUND

Amblyopia is a neurodevelopmental vision disorder that can occur as a result of discordant visual experience during childhood, most often due to strabismus or anisometropia. Strabismic and anisometropic amblyopia impair the visual acuity and contrast sensitivity of one eye. Amblyopic children also experience disruption of binocular vision (reduced or nil stereoacuity and interocular suppression), fixation instability, and accommodative lag. Commonly, amblyopia is treated with spectacles and patching of the fellow eye. Patching improves visual acuity, but binocular vision deficits often remain. Most children treated for amblyopia do not fully recover 20/20 visual acuity despite months or years of treatment and 25-60% experience a recurrence, so amblyopia often persists into adulthood.

Hess et al, (Hess R F, Mansouri B, Thompson B. A new binocular approach to the treatment of amblyopia in adults well beyond the critical period of visual development. Restor Neurol Neurosci 2010; 28:793-802) reported a binocular paradigm for treatment of amblyopia consisting of laboratory-based perceptual learning sessions. In these sessions, dichoptic motion coherence thresholds were measured, and contrast levels in the fellow eye were adjusted to optimize combination of visual information from both eyes and overcome suppression of the amblyopic eye. Nine adults (aged 24 to 49 years) were treated, with amblyopic eye visual acuity ranging from 20/40 to 20/400. Treatment resulted in significantly improved amblyopic eye visual acuity (P<0.008) and stereoacuity (P=0.012), despite 4 of 9 (44%) subjects previously being treated with patching. Knox et al (Knox P J, Simmers A J, Gray L S, Cleary M. An exploratory study: prolonged periods of binocular stimulation can provide an effective treatment for childhood amblyopia. Invest Ophthalmol Vis Sci 2012:53:817-824) studied a similar paradigm with a binocular Tetris game using an in-office, head-mounted display over five 1-hour treatment sessions. Contrast was adjusted to equalize input from each eye. Fourteen children (aged 6 to 14 years) with previously treated amblyopia (patching) were included in the study, with amblyopic eye visual acuity ranging from 20/32 to 20/160. Following treatment mean amblyopic eye visual acuity had improved significantly (P=0.0001) despite previous treatment with patching. Six of the 14 children improved 0.1 logMAR or more and stereoacuity also improved significantly (P=0.02). In another recent study published in 2013, Li et al. (Li J, Thompson B, Deng D, Chan L Y, Yu M, Hess R F. Dichoptic training enables the adult amblyopic brain to learn. Curr Biol 2013;23:R308-309) used the Tetris video game, presented via head-mounted video goggles, one hour per day for two weeks of in-office sessions. Eighteen adults were treated in a crossover design comparing monocular game play with dichoptic game play, using adjustment of contrast to allow for binocular combination. Following treatment, dichoptic game play was found to significantly improve stereoacuity, visual acuity, and contrast balance between fellow and amblyopic eye compared with monocular game play. In these prior studies by Hess and Knox, of note is the finding that visual acuity was found to improve despite prior treatment of amblyopia (44% of cases in Hess study and 100% in Knox study). Regarding amblyopia mechanism (strabismic, anisometropic, or combined), there was no evidence for one type of amblyopia to respond better with binocular amblyopia treatment.

Factors associated with persistent amblyopia were investigated, a window that revealed the key role of binocular vision in the genesis of amblyopia, in its response to amblyopia treatment, and in risk for recurrent and persistent amblyopia. While binocular treatment led to sustained improvement in visual acuity, only short-term treatment options were studied (lasting 2-4 weeks). It would therefore be advantageous to develop treatment options that are performed over a longer period, e.g., over four weeks, in order to optimize recovery of binocular vision.

### SUMMARY

The present method of improving stereoacuity, which can also be used for the treatment of amblyopia, involves presenting complementary yet different visual information to each eye (the weak eye and dominant eye) of a patient, through the use of one or more images or image streams.

The patient then participates in an activity that requires perception of the visual information presented to both eyes (e.g. play a video game where the visual information presented to each eye is necessary to complete the game; watching a television series that has undergone masking as explained in U.S. patent application Ser. No. 15/507,041). The level of the visual information presented to the dominant eye and/or to the weak eye is adjusted such that the level of the visual information presented to the dominant eye is weaker than the level of the visual information presented to the weak eye. The one or more images or one or more image streams are first calibrated by adjusting the level of dominant eye visual information and/or weak eye visual information such that the levels of weak eye visual information and dominant eye visual information allow for the patient to perceive (e.g. when the function of the weak eye to detect the weak eye visual information is first obtained) the weak eye visual information and the dominant eye visual information.

This difference in level of visual information is achieved by adjusting image parameters such as, for instance, the contrast, spatial frequency, temporal frequency, brightness, luminance, colour or any global image parameter, etc., of the visual information presented to one eye, when compared to the visual information presented to the other eye. For instance, the contrast of the visual information presented to the dominant eye may be set at 20% of the contrast of the visual information presented to the weak eye.

The presenting of different visual information to both eyes may be achieved, for instance, by presenting a first image to a first eye and a second image to a second eye that are meant to be viewed dichoptically, adjusting an image such that it can be viewed using anaglyphic glasses where some visual information is adjusted such that it can only be viewed by one eye with the anaglyphic glasses, and other visual information is adjusted such that it can only be viewed by the other eye with the anaglyphic glasses. Some visual information may be common and visible to both eyes.

As the method is performed on the patient, the difference in the level of the visual information between both eyes is set using the image parameters such that the visual information presented to the weak eye is greater than the visual information presented to the dominant eye. Over the course of treatment, the image parameters are adjusted such that the levels of the visual information of both eyes tend to equalize.

However, over a longer course of treatment, the treatment instead undergoes two or more continuous and uninterrupted interval sequences of equalizing the level of the visual information presented to both eyes over time. Therefore, starting from a baseline difference in the level of the image information (an initial ratio), the difference in the level of visual information presented to both eyes may equalize over a first period of time, then the difference in level of the visual information presented to both eyes may return to another ratio or baseline difference of level before repeating over a second period of time the reduction of the difference between the visual information presented to both eyes.

For instance, at the beginning of treatment, the contrast of the visual information presented to the dominant eye may be 20% of the contrast of the visual information presented to the weak eye (e.g. the amblyopic eye). Over time, during the course of a first period, the contrast of the visual information is incrementally adjusted such that the contrast of the visual information presented to dominant eye approaches the contrast of the visual information presented to the weak eye. Then, at the end of the first period and at the beginning of a second period that is continuous with the first period of time, the contrast of the visual information presented to the dominant eye is reset to 20% of the contrast of the visual information presented to the weak eye (or to another starting ratio—such as 15%). The contrast of the visual information is again incrementally adjusted over the course of the second period such that the contrast of the visual information presented to the dominant eye approaches again the contrast of the visual information presented to the weak eye (i.e. decreasing the ratio). This sequential increase and decrease in contrast strength can be performed a plurality of times (i.e. a number of cycles or intervals). During each period, the patient may be prompted to participate in a different activity (e.g. play a different game).

A first broad aspect is a method for treating amblyopia of a patient using one or more images or one or more image streams wherein the one or more images or one or more image streams comprises weak eye visual information and dominant eye visual information. The method includes presenting the weak eye visual information to an weak eye of the patient and the dominant eye visual information to a dominant eye of the patient, wherein the weak eye visual information and the dominant eye visual information are complementary, and a level of the weak eye visual information and a level of the dominant eye visual information are set to an initial ratio such that the level of the weak eye visual information is greater than the level of the dominant eye visual information, and whereby the patient participates in an activity requiring perception of both the weak eye visual information and the dominant eye visual information; treating amblyopia by gradually adjusting the initial ratio such that the level of the dominant eye visual information gradually approaches the level of the weak eye visual information, the gradually adjusting performed over different time intervals of a first period of time; during the amblyopia treatment, continuous after the previous period of time, setting the level of the weak eye visual information and the level of the dominant eye visual information to a second ratio, such that the level of the weak eye visual information is greater than the level of the dominant eye visual information; and continuing to treat amblyopia by gradually adjusting the second ratio such that the level of the dominant eye visual information gradually approaches the level of the weak eye visual information, the gradually adjusting performed over different time intervals of a second period of time, wherein stereoacuity of the patient is further improved after the second period of time than after the first period of time.

Another broad aspect is a method of improving stereoacuity of a patient using one or more images or one or more image streams wherein the one or more images or one or more image streams comprises weak eye visual information and dominant eye visual information. The method includes presenting the weak eye visual information to an weak eye of the patient and the dominant eye visual information to a dominant eye of the patient, wherein the weak eye visual information and the dominant eye visual information are complementary, and a level of the weak eye visual information and a level of the dominant eye visual information are set to an initial ratio such that the level of the weak eye visual information is greater than the level of the dominant eye visual information, and whereby the patient participates in an activity requiring perception of both the weak eye visual information and the dominant eye visual information; improving stereoacuity by gradually adjusting the initial ratio such that the level of the dominant eye visual information gradually approaches the level of the weak eye visual information, the gradually adjusting performed over different time intervals of a first period of time; during the treatment, continuous after the previous period of time, setting the level of the weak eye visual information and the level of the dominant eye visual information to a second ratio, such that the level of the weak eye visual information is greater than the level of the dominant eye visual information; and continuing to improve stereoacuity by gradually adjusting the second ratio such that the level of the dominant eye visual information gradually approaches the level of the weak eye visual information, the gradually adjusting performed over different time intervals of a second period of time, wherein stereoacuity of the patient is further improved after the second period of time than after the first period of time.

In some embodiments, the initial ratio may equal the second ratio.

In some embodiments, the activity may include the patient performing a task requiring the weak eye visual information and the dominant eye visual information.

In some embodiments, a task performed during the first period of time may be different from a task performed during the second period of time.

In some embodiments, the activity may include the patient watching an image stream for entertainment purposes.

In some embodiments, the level of weak eye visual information and the level of dominant eye visual information may be set and adjusted using at least one of contrast, spatial frequency, temporal frequency, brightness, luminance and colour.

In some embodiments, the level of weak eye visual information and the level of dominant eye visual information may be set and adjusted using the contrast.

In some embodiments, the method may include the setting and the gradual adjusting until a period defining an entire treatment has been completed.

In some embodiments, the weak eye visual information and the dominant eye visual information may be obtained by modifying the one or more images or the one or more image streams such that the one or more images or the one or more image streams are adapted for viewing using anaglyphic glasses.

In some embodiments, the one or more images or the one or more image streams may include visual information that can be visible by both the weak eye and the dominant eye.

In some embodiments, the different time intervals of a first period of time may be daily intervals, and wherein the different time intervals of a second period of time may be daily intervals.

In some embodiments, the first period of time may equal four weeks and the second period of time may equal four weeks.

In some embodiments, the gradually adjusting during the first period of time may include incrementally increasing the level of the dominant eye visual information by a given percentage after each of the time intervals of the first period of time, and wherein the gradually adjusting during the second period of time may include incrementally increasing the level of the dominant eye visual information by a given percentage after each of the time intervals of the second period of time.

In some embodiments, the level of the weak eye visual information at the initial ratio may be set using contrast of the one or more images or the one or more image streams, and is set at 100% contrast.

In some embodiments, the gradually approaching may be performed by reducing the weak eye visual information.

In some embodiments, the method is used for the treatment of amblyopia, wherein the treatment of amblyopia results in an improvement in stereoacuity.

Another broad aspect is a non-transitory storage medium comprising program code that, when executed by a processor, causes the processor to present weak eye visual information to an weak eye of a patient and dominant eye visual information to a dominant eye of the patient, wherein the weak eye visual information and the dominant eye visual information are complementary, and a level of the weak eye visual information and a level of the dominant eye visual information are set to an initial ratio such that the level of the weak eye visual information is greater than the level of the dominant eye visual information, and whereby the patient participates in an activity requiring perception of both the weak eye visual information and the dominant eye visual information; gradually adjust the initial ratio such that the level of the dominant eye visual information gradually approaches the level of the weak eye visual information, the gradually adjusting performed over different time intervals of a first period of time; continuous after the previous period of time, set the level of the weak eye visual information and the level of the dominant eye visual information to a second ratio, such that the level of the weak eye visual information is greater than the level of the dominant eye visual information; and gradually adjust the second ratio such that the level of the dominant eye visual information gradually approaches the level of the weak eye visual information, the gradually adjusting performed over different time intervals of a second period of time, wherein stereoacuity of the patient is further improved after the second period of time than after the first period of time.

Another broad aspect is a computing device used for improving stereoacuity of a patient, including a processor; a display for presenting one or more images or one or more image streams wherein the one or more images or one or more image streams comprises weak eye visual information and dominant eye visual information; memory comprising program code that, when executed by the processor, causes the processor to present the weak eye visual information to an weak eye of a patient and the dominant eye visual information to a dominant eye of the patient, wherein the weak eye visual information and the dominant eye visual information are complementary, and a level of the weak eye visual information and a level of the dominant eye visual information are set to an initial ratio such that the level of the weak eye visual information is greater than the level of the dominant eye visual information, and whereby the patient participates in an activity requiring perception of both the weak eye visual information and the dominant eye visual information; gradually adjust the initial ratio such that the level of the dominant eye visual information gradually approaches the level of the weak eye visual information, the gradually adjusting performed over different time intervals of a first period of time; continuous after the previous period of time, set the level of the weak eye visual information and the level of the dominant eye visual information to a second ratio, such that the level of the weak eye visual information is greater than the level of the dominant eye visual information; and gradually adjust the second ratio such that the level of the dominant eye visual information gradually approaches the level of the weak eye visual information, the gradually adjusting performed over different time intervals of a second period of time, wherein stereoacuity of the patient is further improved after the second period of time than after the first period of time.

In some embodiments, the computing device may include a user input interface, and wherein the participating in an activity requires that the patient perform a task requiring the patient to provide input using the user input interface.

In some embodiments, the display may be a head-mounted display.

In some embodiments, the weak eye visual information and the dominant eye visual information may be generated by modifying the one or more images or the one or more image streams such that the one or more images or the one or more image streams are adapted for viewing using anaglyphic glasses.

In some embodiments, the computing device may include a vision tracker, and wherein the gradual adjusting during the first period of time and the gradual adjusting during the second period of time are each respectively performed after verifying that the patient is participating in the activity using the vision tracker, wherein data generated by the vision tracker is indicative of the patient viewing stereoscopically.

### BRIEF DESCRIPTION OF THE DRAWINGS

The invention will be better understood by way of the following detailed description of embodiments of the invention with reference to the appended drawings, in which:

FIG. 1 is a block diagram of an exemplary computer device for improving stereoacuity;

FIG. 2 is a block diagram of an exemplary distributed system for improving stereoacuity;

FIG. 3 is a flowchart diagram of an exemplary method for improving stereoacuity; and

FIG. 4 is a chart showing an exemplary change in the contrast of the dominant eye visual information over the course of a treatment protocol.

### DETAILED DESCRIPTION

The present disclosure relates to improving of stereoacuity, and, in some examples, to the treatment of amblyopia resulting in an improvement of stereoacuity.

More particularly, it has been demonstrated that a method of improving stereoacuity that is structured in intervals or cycles is at least equal, if not more effective at improving stereoacuity, than a treatment protocol that is but a gradual change of levels of visual information over the course of treatment. The treatment protocol results in an improvement of stereoacuity of the patient.

The treatment protocols described herein involve setting the level of visual information presented to the weak eye as being greater (e.g. more visible) than the visual information presented to the dominant eye (e.g. less visible than the visual information presented to the weak eye). As the patient participates in an activity (e.g. watches a video with masking of certain features that is only perceptible by the weak eye; performing a game), the difference between the levels of visual information presented to the weak eye and dominant eye may be adjusted such that the gap in the difference diminishes (e.g. the relative level of visibility of the visual information for dominant eye versus that of the visual information for the weak eye). This can be done gradually during the course of treatment.

The relative levels of visibility of the visual information can be set using the visual parameters of the images. Such visual parameters may include, but are not limited to, the contrast, spatial frequency, temporal frequency, brightness, luminance, colour or any global image parameter, etc., of the visual information presented to one eye, when compared to the visual information presented to the other eye.

The stereoacuity improvement protocol involves setting the relative difference in the level of visual information at a first defined ratio where the level of visual information of the weak eye is greater than the level of visual information of the strong eye (e.g. contrast of visual information for the weak eye is 100%, and the contrast for the visual information for the dominant eye is 20%-or 30%), and undergoing intervals where the relative difference in the levels of visual information gradually disappears (i.e. the relative level of visual information for the dominant eye approaches that of the weak eye, such as a gradually and repeated 10% increase in the contrast of the dominant eye visual information over time) At the start of a new interval, the difference between the levels of the visual information is increased again (e.g. the contrast of visual information for the weak eye is 100% and the contrast for the visual information for the dominant eye is reset at 20%). These intervals are continuous over time and represent an uninterrupted protocol over the course of treatment (i.e. not separate by a time between intervals where the patient does not perform the activity).

The position of the objects may also be important for the user to participate in an activity (e.g. game). For instance, in the examples of virtual reality or augmented reality, failure of the patient to move its hand or finger to the proper position (or other body movements) where an object is located may indicate that the patient is still not seeing stereoscopically, where certain of the objects are not being visible at a proper location. In such an example, the offset of one image or both images may be adjusted.

### DEFINITIONS

In the present disclosure, by “amblyopia”, it is meant a disorder where vision in one eye is weaker than vision in the other eye, which may be caused by a difference in focusing powers between the two eyes.

In the present disclosure, by “complementary”, it is meant being part of a whole. The term complementary is used in relation to the visual information, where it is meant that the weak eye visual information and the dominant eye visual information are part of the same whole, e.g. are part of the same image, where the strong eye and weak eye visual information may be both required to see the whole image, and/or perform a task that is defined by the visual information found in the image or image stream. For instance, in the context of a game, the weak eye visual information may be treasure objects appearing in the image, and the dominant eye visual information may be the chest objects appearing in the image. In order for the subject to complete the task of placing the treasure into the chests, the user has to perceive both the weak eye visual information and the dominant eye visual information, the weak eye visual information and the dominant eye visual information complementary as they are both part of the same image and required to complete the task of the game. In another example, where the performed activity is watching a television program, the weak eye visual information may be certain portions of the image, where the dominant eye visual information may be other portions of the image (e.g. through selective masking), where both the weak eye and dominant eye visual information are required to see the entire image of the television program, and are therefore complementary as they are both required to see the whole image.

In the present disclosure, by “dominant eye”, it is meant the eye of the subject that has stronger vision, where the difference in vision between the two eyes may be as a result of amblyopia.

In the present disclosure, by “initial ratio”, it is meant the initial ratio between the level of weak eye visual information and the level of dominant eye visual information. For instance, in one example, the initial ratio may be set at 20% contrast for the dominant eye visual information and 100% contrast for the weak eye visual information.

In the present disclosure, by “level” of visual information, it is meant a degree of visibility of visual information found in an image. For instance, the level of visual information may be adjusted using visual parameters of the image (e.g. the contrast, spatial frequency, temporal frequency, brightness, luminance, colour, any global image parameter etc.). For instance, lower brightness or contrast may result in a lower visibility of the visual information by the eye of the subject, and therefore a lower level of visual information, when compared to visual information having a higher contrast or brightness.

In the present disclosure, by “participates in an activity”, it includes both passive and active activities, Examples of active activities include playing a video game or performing a diagnostic test where the patient is to provide a form of input (e,g. input on a touchscreen, visual input using eye tracking showing that the patient is performing the game evidenced through eye movement, vocal input picked up by a physician or a microphone). Passive activities include, but are not limited to, watching a movie, television program, online video, etc.

In the present disclosure, by “perception” or “perceive”, it is meant the ability of the patient to see, i.e. for the brain of the patient to process visual information captured by the eyes of the patient.

In the present disclosure, by “period of time”, when associated with interval-based method of improving stereoacuity, means a unit of time to complete a single cycle or interval of treatment. A period of time includes multiple time intervals, where each time interval may be associated with an adjustment in a level of weak eye visual information and/or dominant eye visual information, As such, a period of time is associated with a plurality of gradual adjustments in a level of weak eye visual information and/or dominant eye visual information,

In the present disclosure, by “stereoacuity”, it is meant the smallest detectable depth difference that can be seen in binocular vision,

In the present disclosure, by “subject” or “patient”, used interchangeably herein, it is meant it is meant a human, The term “subject” or “patient” should not bring on any limitations as to the sex or age.

In the present disclosure, by “time interval”, when associated with an interval-based method of improving stereoacuity, it is meant a unit of time that can associated with an adjustment in a level of weak eye visual information and/or dominant eye visual information. A plurality of time intervals defines a period of time of an interval-based treatment for improving stereoacuity.

In the present disclosure, by “treating” or “treatment”, it is meant one or more of (i) inhibiting or arresting part or all of the symptoms of the disease or disorder, and (ii) relieving part or all of the symptoms of the disease or disorder (temporarily or permanently), namely partial or total recovery of stereoscopic vision (temporarily or permanently), and (iii) improving a function of a patient, such as the patient's stereoacuity (temporarily or permanently).

In the present disclosure, by “visual information”, it is meant objects, landscapes, colours, movement, shapes, contours, etc. that are found in and compose the image or image stream. The visual information of an image can be adapted as explained herein such that it is only visible to the weak eye (i.e. weak eye visual information) or such that it is only visible to the dominant eye (i.e dominant eye visual information). Some of the visual information of an image or image stream may be visible to both eyes.

In the present disclosure, by “weak eye”, used interchangeably herein, it is meant the eye of the subject that has weaker vision which may be as a result of amblyopia.

### EXEMPLARY DEVICE AND SYSTEMS FOR IMPROVING STEREOACUITY

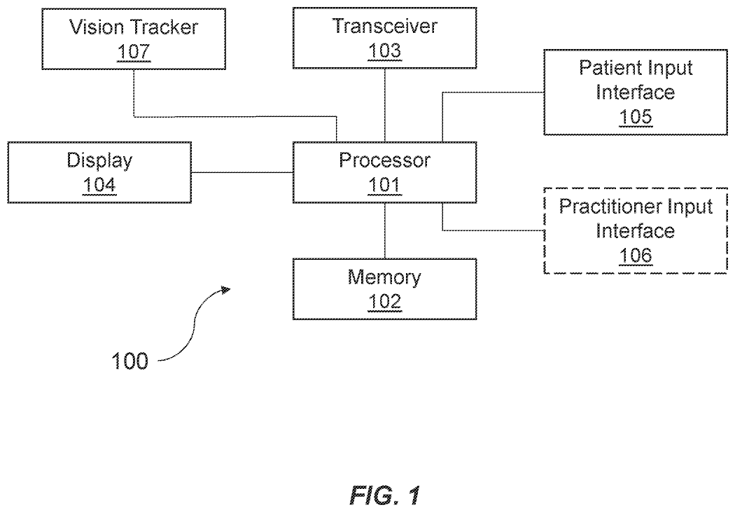

Reference is made to FIG. 1, illustrating an exemplary computing device 100 used for improving stereoacuity, including in the treatment of amblyopia, on which the method for improving stereoacuity may be performed.

The computing device 100 may be a desktop computer, a laptop, a tablet, a smartphone, a console device, etc.

In some embodiments, the computing device 100 may be accompanied by a pair of anaglyphic glasses or stereoscopic glasses that can be used to segregate visual information that is meant for the weak eye from visual information that is meant for the dominant eye. For instance, in the case of anaglyphic glasses, the visual information may be adjusted as a function of the red/blue lenses, such that only certain visual information (e.g, objects or portions of an image) are visible to the weak eye, while other visual information is visible to the dominant eye.

The computing device 100 has a processor 101, memory 102, a display 104.

In some examples, the computing device 100 may have a patient input interface 105.

In some embodiments, the computing device 100 may have a transceiver 103 and/or a practitioner input interface 106.

In some embodiments, the computing device 100 may include a vision tracker 107 to track eye movement of the patient during the participating in the activity in order to assess compliance, e.g., if the eyes are directed to objects appearing the images or image streams necessary for performing the activity.

The vision tracker 107 may include a camera that can capture images or an image stream of the face (or at least the eyes) of the patient, and may include an application program stored in memory 102 of the computing device 100 that, when executed by the processor 101, uses the captured images or image stream to determine the eye position and/or the eye movement of each of the eyes. The generated eye tracking information may be transmitted back provided to the physician, and/or used as input by the computing device 100 to further adjust the difference of image parameters of the images.

In a passive example where a patient is, for example, watching television, the eye tracking information may be received by the computing device 100 to assess if both eyes are functioning to achieve stereopsis, where performance information may not be available as the user is not performing a task.

In fact, in some examples, the performance information may be, or may include, information gathered by the vision tracker 107 when a user performs a task (e.g. that the eyes are moving to where objects are supposed to be perceived based on the game configurations).

The processor 101 is a general-purpose programmable processor. In this example, the processor 101 is shown as being unitary, but the processor may also be multicore, or distributed (e.g. a multi-processor). The processor 101 may be a micro-processor.

The memory 102 may contain program code for execution by the processor 101, such as the program code for executing the method of improving stereoacuity. Therefore, the memory 102 stores program instructions and data used by the processor 101. The computer readable memory 102, though shown as unitary for simplicity in the present example, may comprise multiple memory modules and/or caching. In particular, it may comprise several layers of memory such as a hard drive, external drive (e.g. SD card storage) or the like and a faster and smaller RAM module. The RAM module may store data and/or program code currently being, recently being or soon to be processed by the processor 101 as well as cache data and/or program code from a hard drive. The memory 102 may be non-transitory.

The patient input interface 105 is an interface that allows the patient to provide specific input, such as buttons to allow a user to play a game. For instance, the patient input interface 105 may be a keyboard, a joystick, a controller, a touchpad, a microphone combined with a voice processor, a movement detector, etc. In some examples, the patient input interface 105 may also provide for an option for the user to control the image parameters. In other examples, the image parameters may be controlled by a supervising physician.

In some examples where the patient input interface 105 includes a microphone combined with a voice processor, the voice processor may carry out the commands pronounced by the patient.

In some examples, the computing device 100 may have a practitioner user interface 106 configured to receive input from a medical practitioner or supervising physician. In some embodiments, the physician may control certain of the image parameters using the practitioner user interface 106. In some embodiments, the practitioner user interface 106 may also be configured to transmit information to the physician (e.g. via a wired or wireless connection) regarding, e.g., the patient's performance of the task, such as the patient's results, the settings of the computing device 100, the game that is being played, comments provided by the patient, etc. In some examples, the practitioner user interface 106 may be remote, or part of a remote computer, and may communicate with the computing device 100 using a transceiver, a transmitter and/or a receiver of the computing device 100.

In some examples, the memory 102 stores the program code for the exercises and tasks to be carried out by the patient (e.g. the game). The program code may also include the instructions to adapt the image parameters of the one or more images or the one or more image streams for a corresponding task.

The display 104 is a display that is used to present the one or more images or one or more image streams. In some examples, the difference in visual information for the dominant eye and the visual information for the weak eye may be achieved by using anaglyphic glasses (using the same image, but where some of the objects are configured to only appear to one eye, and some of the features are configured to only be visible to the other eye), or by generating two distinct images or image streams, each with different information content. The display 104 may be, in some examples, a virtual reality headset, a headset display, augmented reality glasses such as Vuzic Blade AR Glasses, the screen of a portable computing device such as a tablet or smartphone, a desktop display, a television set, etc. The display 104 may have a wired connection to the processor 101.

In some examples, the display 104 may be adapted to be viewed using anaglyphic glasses.

The memory 102 and the processor 101 may have a BUS connection. The patient input interface 105 and the practitioner input interface 106 may be connected to the processor via a wired connection.

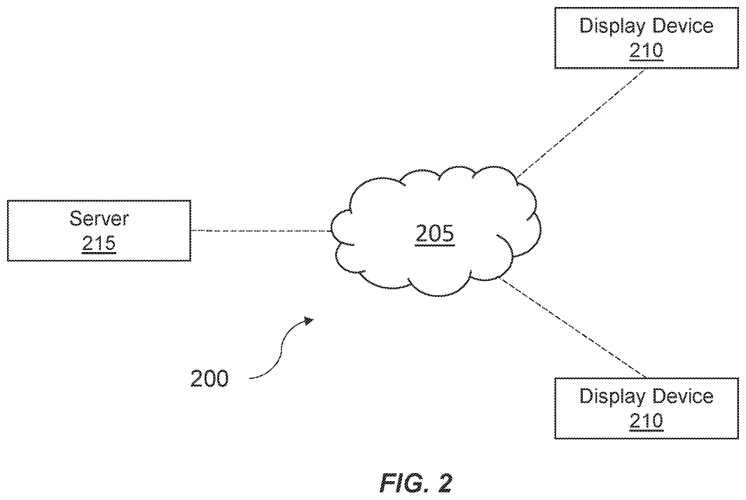

Reference is now made to FIG. 2, illustrating an exemplary system 200 for providing a method of improving stereoacuity to one or more subjects.

One or more patients may receive amblyopic treatment following an amblyopic treatment protocol respectively administered on one or more display devices 210. Exemplary display devices 210 may be, but are not limited to, a desktop computer, a laptop, a tablet, a smartphone, a console device, a display screen, a television, etc.

The images or image streams may be transmitted to the one or more display devices 210, over the web 205, from a remote server 215.

For instance, the one or more images or one or more image streams may allow the subject to participate in an activity as defined herein, where the one or more images or one or more image streams are adapted as a function of the activity and the method of improving stereoacuity.

The server 215 may also receive feedback information on the patient and with respect to the method of improving stereoacuity—e.g. the amblyopia treatment (e.g. input when playing the game, the results of playing the game, vision tracker feedback information, etc.) from the one or more display devices 210, as a function of time, over the web 205. The server 215 may store the feedback information, and/or transmit the information to a remote computer of a physician (not shown).

### EXEMPLARY METHOD OF IMPROVING STEREOACUITY

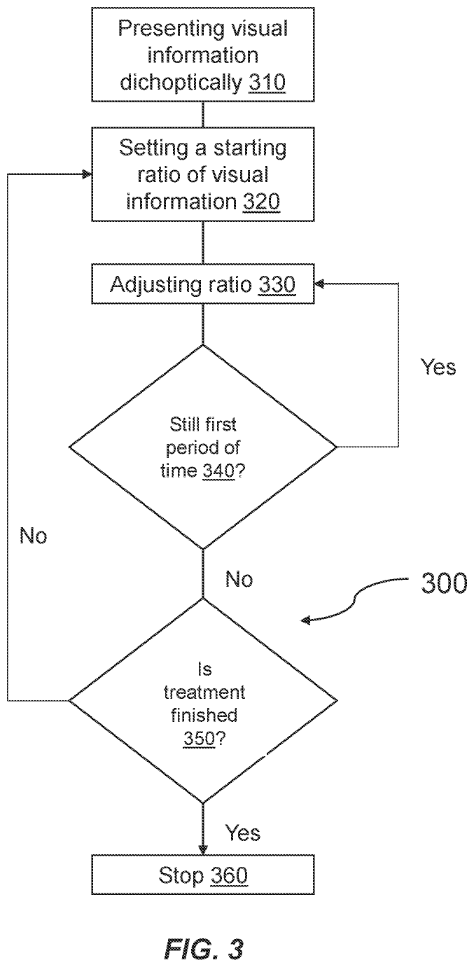

Reference is now made to FIG. 3, illustrating an exemplary method 300 of improving stereoacuity following an interval-based treatment protocol, which may be performed as or as part of amblyopia treatment. The method 300 may be implemented or carried out using, for instance, a computing device 100 or system 200, but is not limited to being implemented or carried out by same. The method 300 may be stored in the memory of a computing device, and executed by a processor, the processor carrying out the steps of the method 300.

For the purposes of illustration, method 300 will be explained in the context of amblyopia treatment. However, method 300 may be performed to improve the stereoacuity of a subject, including a subject that does not have amblyopia. As a result, method 300 may be performed to treat amblyopia, and/or to treat the loss of stereoacuity caused by other disorders, diseases and/or conditions.

The visual information conveyed in one or more images or one or more image streams is presented dichoptically to the eyes of the patient at step 310. Weak eye visual information is presented to the weak eye and dominant eye visual information is presented to the dominant eye. The weak eye visual information and the dominant eye visual information are complementary. There may also be visual information that may be presented or visible to both the weak eye and the dominant eye.

For instance, adapting an image or image stream for obtaining weak eye visual information and dominant eye visual information may be achieved by modifying the image such that when the patient wears anaglyphic glasses, some information is only visible to one eye and some information is only visible to the other eye. In some examples, some information in grey may be visible to both eyes.

The level of the dominant eye visual information and the level of the weak eye visual information is set at an initial ratio at step 320. The initial ratio is such that the level of the weak eye visual information is greater than the level of the dominant eye visual information, such that the weak eye visual information is more visible than the dominant eye visual information.

Setting the initial ratio may be performed by adapting one or more image parameters of the one or more images or the one or more image streams containing the weak eye visual information and the dominant eye visual information. Such image parameters may include, but are not limited to, contrast, spatial frequency, temporal frequency, brightness, luminance, colour or any global image parameter, etc.

For instance, the contrast of the weak eye visual information may be set at 100%, where the contrast of the dominant eye visual information may be set at 20%.

In another example, the brightness of the weak eye visual information may be set at 100%, where the brightness of the dominant eye visual information may be set at 10%.

The patient may be prompted to begin the amblyopia treatment protocol. The patient participates in an activity as defined herein.

After a given time interval defined in the first period of time (e.g. after data is received that the patient is successfully performing or participating in the activity), the relative ratio between the level of the dominant eye visual information and the level of the weak eye visual information is adjusted such that the level of the dominant eye visual information approaches by an increment the level of the weak eye visual information at step 330. For instance, the contrast of the dominant eye visual information may be increased by 10% (resulting in a contrast of 22% if the original contrast of the dominant eye visual information was of 20%).

The relative ratio between the level of the dominant eye visual information and the level of the weak eye visual information is adjusted such that the level of the dominant eye visual information approaches by an increment the level of the weak eye visual information after the given time intervals during the course of the first period of time (e.g after each day).

After each given time interval of the period of time, it is queried if the treatment is still in the first period of time at step 340. If the treatment is still in the same period of time, then the relative ratio is additionally increased, repeating step 330. As step 330 is repeated during the course of the first period of time (e.g. period of time being four weeks, the time intervals being quantified as days), the level of the dominant eye visual information continues to incrementally approach the level of the weak eye visual information (e.g. can either increase the level of the dominant eye visual information or decrease the level of the weak eye visual information).

If, after adjusting the relative ratio at step 330, it is determined that the first period of time has lapsed at step 340, then it is queried if the entire treatment is complete at step 350.

A treatment protocol will include at least two periods of time, equating to two subsequent intervals or cycles defined by their respective periods of time.

If the treatment is not completed, then another period of time, continuous with and uninterrupted from the previous period of time, will commence.

The relative ratio between the level of the dominant eye visual information and the weak eye visual information is increased, where the difference between the level of dominant eye visual information and the weak eye visual information is greater than at the end of the previous period of time. However, the level of the weak eye visual information is still greater than the level of the dominant eye visual information.

As such, the ratio of the level of the weak eye visual information and the level of the dominant eye visual information is set at a new starting ratio, returning to step 320.

In some examples, the new starting ratio of the new period of time may be equal to the starting ratio of the previous period of time. In other examples, the new starting ratio of the new period of time may be different from the starting ratio of the previous period of time.

Again, the relative ratio of the levels of dominant eye visual information and the weak eye visual information may be gradually and incrementally adjusted as the patient passes through the different consecutive time intervals of the new period of time, cycling through steps 330 and 340. The increments in changes between the level of the weak eye visual information and the dominant eye visual information may be consistent with those of the previous period of time, or may be different from those of the previous period of time.

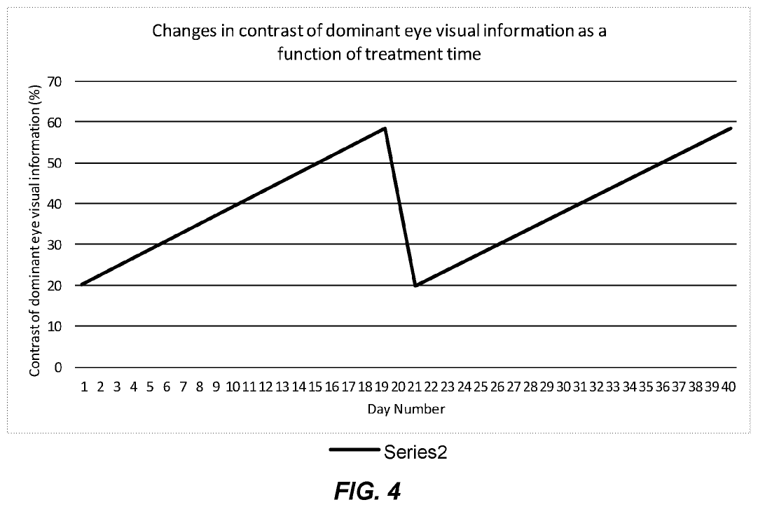

An exemplary change in the level of dominant eye visual information over the course of time of a treatment protocol is illustrated at FIG. 4, where the level of dominant eye visual information is set and adjusted using contrast. At day 1, the contrast of the dominant eye visual information is set at 20%. From day 2 to day 20, the contrast of the dominant eye visual information is gradually incremented by intervals of 10% of the initial contrast value of the dominant eye visual information (e.g. 2%). At day 21, marking the second period of time, the contrast of the dominant eye visual information is set again at 20%. From day 21 to day 40, day 40 marking the end of the exemplary treatment, the contrast of the dominant eye visual information is again gradually incremented by intervals of 10% of the initial contrast value of the dominant eye visual information (e.g, 2%). It will understood that the amount of the change of the level of the dominant eye visual information or the weak eye visual information over time, the periods marking the time intervals of a period of time, the length of the different periods of time of the treatment, the initial level of dominant eye visual information, and the level of dominant eye visual information at the beginning of subsequent time intervals marked by subsequent periods of time, may be different from the present example without departing from the present teachings.

At step 340, if it is determined that the new period of time has lapsed, then it is queried again if the total treatment is finished (e.g. based on the allotted time for the treatment) at step 350.

After each period of time, the stereoacuity of the patient should gradually improve.

If it is determined that the total treatment has not finished at step 350, then a new period of time of the treatment is set to begin, the method returning to step 320.

If it is determined that the total treatment has finished, then the treatment stops at step 360.

After the end of the interval-based treatment protocol, the patient's stereoacuity may improve to a greater extent than if the patient were to follow a treatment protocol of the same length with, instead, a gradual increase in the level of dominant eye visual information when compared to the weak eye visual information, instead of cycling through the intervals of the ratios of levels of dominant eye visual information and weak eye visual information resulting from the carrying out of method 300.

### EXEMPLARY STUDY

The following exemplary study is provided to enable the skilled person to better understand the present disclosure. As it is but an illustrative and representative example, it should not limit the scope of the present disclosure, only added for illustrative and representative purposes, It will be understood that other exemplary studies may be used to further illustrate and represent the present disclosure without departing from the present teachings.

Participants:

Four binocular amblyopia treatment contrast-rebalancing protocols were evaluated in order to determine which yields the greatest visual acuity improvement in an 8-week treatment period.

Participants included 67 children with anisometropia, strabismus, or combined mechanism amblyopia, age 4-10 years. Participants were randomly assigned to one of four study arms (15 per arm) and asked to play the binocular games 1 hr/day for 5 days/wk for 8 weeks.

Even though children were used for the study, it will be understood that the present protocols are equally applicable to adults.

Selection of Participants:

Participants were selected with the following criteria. The children were aged 4-10 years, male or female. Each participant was diagnosed with amblyopia with amblyopic eye visual acuity of 20/40-20/125, fellow eye visual acuity 20/16-20/25, and interocular difference in visual acuity of 3 lines or more. The participants are anisometropic (with or without microtropia) or fully corrected esotropia (no tropia present with glasses), and have no strabismus greater than 5 prism diopters. The participants were wearing glasses (if needed) for 8 weeks or had no change in visual acuity with classes at two visits at least 4 weeks apart. The participants were able to demonstrate understanding and ability to play binocular games during the enrollment visit. A signed informed consent obtained for each participant.

Participants were excluded if a coexisting ocular or systemic disease was found, there was a developmental delay or poor ocular alignment (strabismus >5 prism diopters)

Measurement of visual acuity to determine eligibility and, if eligible, to provide a baseline measurement, was measured with clinical HOTV or ETDRS letter charts, Measurement of stereoacuity, interocular suppression, fixation stability, and monocular accommodation was performed to provide a baseline measurement. Stereoacuity was measured with clinicalPreschool Randot and Randot Butterfly tests. Interocular suppression was measured with an eyechart presented to each eye on a standard 3D TV. Fixation stability was recorded as the child fixates a dot, using a clinical EyeLink 1000 vision tracker. Monocular accommodation was measured while the child looks at clinical visual acuity letter chart designed to be viewed at near (33 cm).

Protocol:

The enrolled participants played the binocular games on a tablet while wearing red-green filter glasses to separate images to each eye.

The four binocular amblyopia treatment contrast-rebalancing protocols were the following. Each of the four randomly assigned one of contrast-incrementing protocols staring with 20% fellow eye contrast. The contrast increments were the following for each of the four protocols a) 10%, b) 5%, c) 0%, and d) 10% for 4 weeks then reset to 20% and repeat for final 4 weeks. Children played one contrast-balanced dichoptic action tablet game—Dig Rush™ game (a role-playing-game with puzzle components involving the location of items only visible to the weak eye, and the solving of puzzles using these located items)—for the first four weeks and a new action game—Monster Burner™ game (a game involving the selection of a certain variety of monster only visible to the weak eye)—for the second four weeks, 1 hr/day, 5 days/week. Best corrected visual acuity (BCVA), stereoacuity, and suppression were assessed at baseline and 8-week outcome visits.

A blocked randomization order was provided in sealed envelopes by the consultant statistician for the placement of the children in the different groups.

Vision was tested at baseline, and at 2, 4, 6 and 8 weeks.

At the baseline visit, each child was provided a loaned tablet and two pairs of glasses with red and green filters.

At each visit, visual acuity, stereoacuity, and interocular suppression were measured. The tablet log was downloaded that tracks time spent playing the game to evaluate treatment adherence and the fellow eye contrast changes to evaluate game progress. At baseline, 4, and 8 weeks, fixation stability and monocular accommodation were assessed.

Results:

The results were analyzed as follows.

One-way ANOVA comparing amblyopic eye logMAR visual acuity change (baseline—8 week) among the 4 groups, with planned pairwise comparisons was obtained for the participants.

The proportions of children whose visual acuity improves to 0.2 logMAR or better by 8 weeks and their 95% confidence intervals were calculated. Severity of suppression was analyzed with one-way ANOVA, with planned pairwise comparisons. Stereoacuity outcome at 8 weeks was analyzed with Kruskall-Wallis ANOVA, with planned pairwise comparisons (nonparametric outcome measure). Tablet compliance logs were tabulated and summarized with descriptive statistics. One-way ANOVA comparing change in fixation stability (baseline—8 week) among the 4 groups, with planned pairwise comparisons was performed. One-way ANOVA comparing change in amblyopic eye accommodative lag (baseline—8 week) among the 4 groups, with planned pairwise comparisons was also performed. Correlations among hours of game play, contrast level achieved, changes in visual acuity, stereoacuity, severity of suppression, fixation stability, and amblyopic eye accommodative lag were analyzed to examine any dose-response relationships and to explore the relationship between suppression and amblyopia.

At baseline, mean amblyopic eye BCVA±SE was 0.49±0.06 logMAR (˜20/60). After 8 weeks of binocular treatment (32.2±3.9 of prescribed 40 hours), mean BCVA improved 0.14±0.02 logMAR (p<0.0001). All four contrast-incrementing protocols yielded similar BCVA improvements (0.14, 0.13, 0.12, 0.16, respectively p=0.48). Younger children improved more than older children (0.16 vs. 0.12, p=0.02). Random dot stereoacuity (p=0.002) and Worth-4 dot suppression (p=0.0004) also improved.

Contrast-balanced binocular experience yielded significant BCVA, suppression, and stereoacuity improvements in all four contrast-incrementing protocols, especially in younger children.

In fact, the improvement recorded for participants using the interval treatment protocol (protocol d)), experienced a higher BCVA improvement when compared to the other contrast-incrementing protocols. As such, this is an indicator that an interval protocol, where the different contrast levels of the two sets of visual information is first diminished over a given period, then set back at or set closer to the initial gap, then diminished during another given period, may be more effective in treating amblyopia than the other treatment protocols. The number of intervals of the protocol may be more than two.

The improvement in stereoacuity resulting from the performance of the above protocols are not limited to treating amblyopia, but may also be used for the improvement of stereoacuity in patient that do not have amblyopia but still suffer from reduced stereoacuity.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

1. A method for improving stereoacuity of a patient using one or more images or one or more image streams wherein said one or more images or one or more image streams comprises weak eye visual information and dominant eye visual information, comprising:
a) presenting said weak eye visual information to a weak eye of said patient and said dominant eye visual information to a dominant eye of said patient, wherein said weak eye visual information and said dominant eye visual information are complementary, and a level of said weak eye visual information and a level of said dominant eye visual information are set to an initial ratio such that said level of said weak eye visual information is greater than said level of said dominant eye visual information, and whereby said patient participates in an activity requiring perception of both said weak eye visual information and said dominant eye visual information;
b) improving stereoacuity by gradually adjusting said initial ratio such that said level of said dominant eye visual information gradually approaches said level of said weak eye visual information, said gradually adjusting performed over different time intervals of a first period of time;
c) continuous after the previous period of time, setting said level of said weak eye visual information and said level of said dominant eye visual information to a second ratio, such that said level of said weak eye visual information is greater than said level of said dominant eye visual information; and
d) continuing to improve stereoacuity by gradually adjusting said second ratio such that said level of said dominant eye visual information gradually approaches said level of said weak eye visual information, said gradually adjusting performed over different time intervals of a second period of time, wherein stereoacuity of said patient is further improved after said second period of time than after said first period of time.

2. The method of claim 1, wherein said initial ratio equals said second ratio.

3. The method of claim 1, wherein said activity comprises said patient performing a task requiring said weak eye visual information and said dominant eye visual information.

4. The method of claim 3, wherein a task performed during said first period of time is different from a task performed during said second period of time.

5. The method of claim 1, wherein said activity includes said patient watching an image stream for entertainment purposes.

6. The method of claim 1, wherein said level of weak eye visual information and said level of dominant eye visual information are set and adjusted using at least one of contrast, spatial frequency, temporal frequency, brightness, luminance and colour.

7. The method of claim 6, wherein said level of weak eye visual information and said level of dominant eye visual information are set and adjusted using said contrast.

8. The method of claim 1, further comprising repeating c) and d) until a period defining an entire treatment has been completed.

9. The method of claim 1, wherein said weak eye visual information and said dominant eye visual information are obtained by modifying said one or more images or said one or more image streams such that said one or more images or said one or more image streams are adapted for viewing using anaglyphic glasses.

10. The method of claim 1, wherein said one or more images or said one or more image streams comprises visual information that can be visible to both said weak eye and said dominant eye.

11. The method of claim 1, wherein said different time intervals of a first period of time are daily intervals, and wherein said different time intervals of a second period of time are daily intervals.

12. The method of claim 1, wherein said first period of time equals four weeks and said second period of time equals four weeks.

13. The method of claim 1, wherein said gradually adjusting during said first period of time comprises incrementally increasing said level of said dominant eye visual information by a given percentage after each of said time intervals of said first period of time, and wherein said gradually adjusting during said second period of time comprises incrementally increasing said level of said dominant eye visual information by a given percentage after each of said time intervals of said second period of time.

14. The method of claim 1, wherein said level of said weak eye visual information at said initial ratio is set using contrast of said one or more images or said one or more image streams, and is set at 100% contrast.

15. The method of claim 1, wherein said gradually approaching is performed by reducing said level of said weak eye visual information.

16. The method of claim 1, wherein said method of improving stereoacuity is performed to treat amblyopia.

17. A non-transitory storage medium comprising program code that, when executed by a processor, caused the processor to:
a) present weak eye visual information to an weak eye of a patient and dominant eye visual information to a dominant eye of said patient, wherein said weak eye visual information and said dominant eye visual information are complementary, and a level of said weak eye visual information and a level of said dominant eye visual information are set to an initial ratio such that said level of said weak eye visual information is greater than said level of said dominant eye visual information, and whereby said patient participates in an activity requiring perception of both said weak eye visual information and said dominant eye visual information;
b) gradually adjust said initial ratio such that said level of said dominant eye visual information gradually approaches said level of said weak eye visual information, said gradually adjusting performed over different time intervals of a first period of time;
c) continuous after the previous period of time, set said level of said weak eye visual information and said level of said dominant eye visual information to a second ratio, such that said level of said weak eye visual information is greater than said level of said dominant eye visual information; and
d) gradually adjust said second ratio such that said level of said dominant eye visual information gradually approaches said level of said weak eye visual information, said gradually adjusting performed over different time intervals of a second period of time, wherein stereoacuity of said patient is further improved after said second period of time than after said first period of time.

18. A computing device used for improving stereoacuity of a patient comprising:
a processor;
a display for presenting one or more images or one or more image streams wherein said one or more images or one or more image streams comprises weak eye visual information and dominant eye visual information;
memory comprising program code that, when executed by said processor, causes said processor to:
a) present said weak eye visual information to an weak eye of a patient and said dominant eye visual information to a dominant eye of said patient, wherein said weak eye visual information and said dominant eye visual information are complementary, and a level of said weak eye visual information and a level of said dominant eye visual information are set to an initial ratio such that said level of said weak eye visual information is greater than said level of said dominant eye visual information, and whereby said patient participates in an activity requiring perception of both said weak eye visual information and said dominant eye visual information;
b) gradually adjust said initial ratio such that said level of said dominant eye visual information gradually approaches said level of said weak eye visual information, said gradually adjusting performed over different time intervals of a first period of time;
c) continuous after the previous period of time, set said level of said weak eye visual information and said level of said dominant eve visual information to a second ratio, such that said level of said weak eye visual information is greater than said level of said dominant eye visual information; and
d) gradually adjust said second ratio such that said level of said dominant eye visual information gradually approaches said level of said weak eye visual information, said gradually adjusting performed over different time intervals of a second period of time, wherein stereoacuity of said patient is further improved after said second period of time than after said first period of time.

19. The computing device of claim 18, further comprising a user input interface, and wherein said participating in an activity requires that said patient perform a task requiring said patient to provide input using said user input interface.

20. The computing device of claim 18, wherein said display is a head-mounted display.

21. The computing device of claim 18, wherein said weak eye visual information and said dominant eye visual information are generated by modifying said one or more images or said one or more image streams such that said one or more images or said one or more image streams are adapted for viewing using anaglyphic glasses.

22. The computing device of claim 18, further comprising a vision tracker, and wherein said gradual adjusting during said first period of time and said gradual adjusting during said second period of time are each respectively performed after verifying that said patient is participating in said activity using said vision tracker, wherein data generated by said vision tracker is indicative of said patient viewing stereoscopically.
